(19) United States
(12) Patent Application Publication
(10) Pub. No.: US 2011/0232818 A1
(43) Pub. Date: Sep. 29, 2011

(54) Tire for Heavy Vehicles Comprising at Least in Each Shoulder, at Least Two Additional Layers in the Crown Reinforcement

(76) Inventor: Michael Cogne, Riom (FR)

(21) Appl. No.: 13/061,889

(22) PCT Filed: Sep. 1, 2009
(86) PCT No.: PCT/EP09/61291

§ 371 Date: May 24, 2011

(30) Foreign Application Priority Data
Sep. 2, 2008 (FR) 0855889

(51) Int. Cl. B60C 9/16

(52) U.S. Cl. 152/548

(57) ABSTRACT

A tire comprising a crown reinforcement formed of at least two working crown layers of reinforcing elements. The tire additionally comprises, in each shoulder, at least two layers formed by circumferential winding of a complex strip formed of two layers including continuous reinforcing elements passing from one layer to the other, the said reinforcing elements being parallel within a layer and crossed from one layer to the other at angles with respect to the circumferential direction that are identical in terms of absolute value, the said additional complex strip being radially adjacent to the edge of a working crown layer, and the axially outer end of the said additional complex strip being situated a distance from the equatorial plane of the tire that is at least equal to the distance separating from the said plane that end of the working layer to which it is adjacent.

The present invention relates to a tire with a radial carcass reinforcement and more particularly to a tire intended to be fitted to vehicles that carry heavy loads and drive at a sustained speed, such as, for example, lorries, tractors, trailers or buses that go on the road.

Reinforcements or reinforcing structures for tires, and particularly for tires of vehicles of the heavy-goods type, are currently—and usually—made up of a stack of one or more plies conventionally known as “carcass plies”, “crown plies”, etc. This way of naming the reinforcements stems from the method of manufacture which consists in producing a series of to semi-finished products in the form of plies, provided with threadlike reinforcing elements, often longitudinal, which are then assembled or stacked in order to build a tire preform. The plies are produced flat, with large dimensions, and then cut to suit the dimensions of a given product. The plies are also assembled, initially, substantially flat. The preform thus produced is then shaped into the toroidal profile typical of tires. The semi-finished products known as “finishing” products are then applied to the preform to obtain a product that is ready to be vulcanized.

A “conventional” type of method such as this entails, particularly during the phase of manufacturing the tire preform, the use of an anchoring element (generally a bead wire) which is used to anchor or secure the carcass reinforcement in the region of the beads of the tire. Thus, in this type of method, a portion of all the plies (or just some of the plies) that make up the carcass reinforcement is wrapped around a bead wire positioned in the bead of the tire. Thus, the carcass reinforcement is anchored in the bead.

The fact that this conventional type of method is widespread throughout the tire-manufacturing industry, in spite of there being numerous alternative ways of producing the plies and the assemblies, has led those skilled in the art to employ a vocabulary hinged on the method; hence the terminology generally accepted which in particular includes the terms “plies”, “carcass”, “bead wire”, “shaping” to denote the change from a flat profile to a toroidal profile, etc.

Nowadays, there are tires which do not, strictly speaking, have any “plies” or “bead wires” consistent with the above definitions. For example, document EP 0 582 196 describes tires manufactured without the use of semi-finished products in the form of plies. For example, the reinforcing elements of the various reinforcing structures are applied directly to the adjacent layers of rubber compounds, all of this being applied in successive layers to a toroidal core the shape of which allows a profile similar to the final profile of the tire being manufactured to be obtained directly. Thus, in this case, there are no longer any “semi-finished” products, or any “plies” or any “bead wires”. The base products, such as the rubber compounds and the reinforcing elements in the form of threads or filaments, are applied directly to the core. Because this core is of toroidal shape, there is no longer any need to shape the preform in order to change from a flat profile to a profile in the shape of a torus.

Furthermore, the tires described in that document do not have any “traditional” wrapping of the carcass ply around a bead wire. That type of anchorage is replaced by an arrangement whereby circumferential threads are positioned adjacent to the said sidewall reinforcing structure, everything being embedded in an anchoring or bonding rubber compound.

There are also methods of assembly onto a toroidal core that employ semi-finished products specifically adapted for rapid, effective and simple placement on a central core. Finally, it is also possible to use a hybrid comprising both certain semi-finished products for achieving certain architectural aspects (such as plies, bead wires, etc.) while others are achieved by applying compounds and/or reinforcing elements directly.

In this document, in order to take account of recent technological evolutions both in the field of manufacture and in the design of products, the conventional terms such as “plies” “bead wires”, etc., are advantageously replaced by teens which are neutral or independent of the type of method used. Thus, the term “carcass-type reinforcement” or “sidewall reinforcement” can be used to denote the reinforcing elements of a carcass ply in the conventional method and the corresponding reinforcing elements, generally applied to the sidewalls, of a tire produced according to a method that does not involve semi-finished products. The term “anchoring region”, for its part, can denote the “traditional” wrapping of the carcass ply around a bead wire in a conventional method, just as easily as it can denote the assembly formed by the circumferential reinforcing elements, the rubber compound and the adjacent sidewall reinforcing portions of a bottom region produced using a method that involves application onto a toroidal core.

Generally, in tires of the heavy-goods type, the carcass reinforcement is anchored on each side in the bead region and is radially surmounted by a crown reinforcement consisting of at least two layers, which are superposed and formed of threads or cords that are parallel within each layer. It may also comprise a layer of metal threads or cords with low extensibility making an angle of between 45° and 90° with the circumferential direction, this ply, known as the triangulation ply, being situated radially between the carcass reinforcement and the first crown ply known as the working ply, formed of parallel threads or cords at angles of at most 45° in terms of absolute value. The triangulation ply forms, with at least the said working ply, a triangulated reinforcement which, under the various stresses to which it is subjected, suffers little by way of deformation, the triangulation ply having the essential role of reacting the transverse compressive loads to which the collection of reinforcing elements is subjected in the region of the crown of the tire.

The crown reinforcement comprises at least one working layer; when the said crown reinforcement comprises at least two working layers, these are formed of inextensible metal reinforcing elements that are parallel to one another within each layer and crossed from one layer to the next, making angles of between 10° and 45° with the circumferential direction. The said working layers that form the working reinforcement may even be covered with at least one layer known as a protective layer and formed of reinforcing elements that are advantageously made of metal and extensible, known as elastic elements.

In the case of tires for “heavy-goods” vehicles, just one protective layer is usually present and its protective elements are, in most cases, directed in the same direction and at the same angle in terms of absolute value as those of the reinforcing elements of the radially outermost and therefore radially adjacent working layer. In the case of construction machinery tires intended to run over fairly uneven ground, the presence of two protective layers is advantageous, the reinforcing elements being crossed from one layer to the next and the reinforcing elements in the radially inner protective layer being crossed with the inextensible reinforcing elements in the radially outer working layer adjacent to the said radially inner protective layer.

Cords are said to be inextensible when the said cords exhibit a relative elongation of at most 0.2% under a tensile force equal to 10% of the breaking strength.

Cords are said to be elastic when the said cords exhibit a relative elongation of at least 4% under a tensile force equal to the breaking strength.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is the direction that intersects the axis of rotation of the tire and is perpendicular thereto.

The axis of rotation of the tire is the axis about which it rotates under normal use.

A radial or meridian plane is a plane which contains the axis of rotation of the tire.

The circumferential mid-plane or equatorial plane is a plane perpendicular to the axis of rotation of the tire and which divides the tire into two halves.

Certain current tires known as “road” tires are intended to run at high speed for increasingly long distances because of improvements to the road network and because of the growth of the motorway network throughout the world. All of the conditions under which a tire such as this is called upon to run undoubtedly allow the number of kilometers covered to be increased, as tire wear is lower, but on the other hand the endurance of this tire, and particularly of the crown reinforcement, is thereby penalized.

This is because there are stresses in the crown reinforcement and, more particularly, shear stresses between the crown layers, combined with a not-insignificant increase in the operating temperature at the ends of the axially shortest crown layer, which cause cracks to appear and spread in the rubber at the said ends.

In order to improve the endurance of the crown reinforcement of the type of tire under investigation, solutions relating to the structure and quality of the layers and/or profiles of rubber compounds positioned between and/or around the ends of the plies and more particularly the ends of the axially shortest ply have already been provided.

Patent FR 1 389 428, in order to improve the resistance to degradation of the rubber compounds situated near the edges of the crown reinforcement, recommends the use, in conjunction with a low-hysteresis tread strip, of a rubber profile that covers at least the sides and the marginal edges of the crown reinforcement and consists of a low-hysteresis rubber compound.

Patent FR 2 222 232, in order to avoid separation between the crown reinforcement plies, teaches coating the ends of the reinforcement in a cushion of rubber, the Shore A hardness of which differs from that of the tread strip surmounting the said reinforcement, and which is higher than the Shore A hardness of the profile of rubber compound positioned between the edges of crown reinforcement and carcass reinforcement plies.

French application FR 2 728 510 proposes the placement, on the one hand between the carcass reinforcement and the crown reinforcement working ply radially closest to the axis of rotation, of an axially continuous ply formed of inextensible metal cords making an angle of at least 60° with the circumferential direction and the axial width of which is at least equal to the axial width of the shortest working crown ply and, on the other hand, between the two working crown plies, of an additional ply formed of metal elements directly substantially parallel to the circumferential direction.

Prolonged running of the tires thus constructed has caused fatigue breakages of the cords in the additional ply and, more particularly, of the edges of the said ply, regardless as to whether or not the so-called triangulation ply is present.

In order to remedy such disadvantages and improve the endurance of the crown reinforcement of these tires, French application WO 99/24269 proposes, on each side of the equatorial plane and in the immediate axial continuation of the additional ply of reinforcing elements substantially parallel to the circumferential direction, for the two working crown plies formed of reinforcing elements that are crossed from one ply to the next to be coupled over a certain axial distance, and then dissociated using profiles made of rubber compound at least over the remainder of the width common to the said two working plies.

One objective of the invention is to provide tires for “heavy-goods” vehicles the endurance performance of which is further improved over conventional tires.

This objective is achieved according to the invention by a tire with a radial carcass reinforcement comprising a crown reinforcement formed of at least two working crown layers of inextensible reinforcing elements, crossed from one ply to the other making angles of between 10° and 45° with the circumferential direction, and itself radially capped by a tread strip, the said tread strip being connected to two beads via two sidewalls, the said tire additionally comprising, in each shoulder, at least two layers formed by circumferential winding of a complex strip formed of two layers consisting of continuous reinforcing elements passing from one layer to the other, the said reinforcing elements being parallel within a layer and crossed from one layer to the other at angles with respect to the circumferential direction that are identical in terms of absolute value, the said additional complex strip being radially adjacent to the edge of a working crown layer, and the axially outer end of the said additional complex strip being situated a distance from the equatorial plane of the tire that is at least equal to the distance separating from the said plane that end of the working layer to which it is adjacent.

The axial widths of the layers of reinforcing elements or axial positions of the ends of the said layers are measured on a cross section of a tire, the tire therefore being in an uninflated state.

Tests carried out on tires thus defined according to the invention have revealed that the performance in terms of tire endurance is improved over tires of a more traditional design that do not have the additional layers as described according to the invention. One interpretation of these results might be to note that the additional complex strip, more specifically the reinforcing elements in the additional complex strip, limit the spread of any beginnings of cracks there might be at the end of the working layer to which it is adjacent. Such an action may potentially be the result of a reinforcing of the rubbery masses of liner between the reinforcing elements of the said working layer with the reinforcing elements of the additional complex strip.

The tire thus produced according to the invention and, more specifically, the complex strip, further comprises layers of reinforcing elements that are parallel within a layer and crossed from one layer to the other, which have no ends on their edges and which are relatively simple to implement; what happens is that two layers are produced simultaneously by circumferential winding of a prefabricated element that the complex strip constitutes. Circumferential winding is in fact a relatively simple technique to perform and which can be carried out at high speed; further, as recalled hereinabove, at least two layers are produced simultaneously.

The absence of free ends of the layers of the complex strip means that potential sources of disruption of the polymer compounds or of defects associated with the cutting of the fabrics that make up the crown reinforcing layers are not recreated.

A circumferential winding corresponds to a winding of the complex strip in such a way that the turns formed make an angle of less than 8° with the circumferential direction.

According to one preferred embodiment of the invention, the radial distance between the respective reinforcing elements of each of the crown layers forming a complex strip is less than the thickness of a crown layer and preferably less than half the thickness of a crown layer.

Within the meaning of the invention, the radial distance between the respective reinforcing elements of each of the crown layers is measured radially between the respectively upper and lower generatrices of the said reinforcing elements of the radially inner and radially outer crown layers. The thickness of the crown layer is also measured in the radial direction.

Preferably also, with each of the layers being formed of reinforcing elements between two liners made of polymer compounds each forming a thickness radially on the outside and radially on the inside of the said reinforcing elements, the radial distance between the respective reinforcing elements of each of the crown layers is substantially equivalent to the sum of the thickness of polymer compound in the liner radially on the outside of the reinforcing elements of the radially inner crown layer and of the thickness of polymer compound in the liner radially on the inside of the reinforcing elements of the radially outer crown layer.

The complex strip may be obtained in advance using a method that involves flattening a tube, itself formed by winding, in contiguous turns at a given angle with respect to the longitudinal direction of the tube, a tape in which reinforcing elements are parallel to one another and to the longitudinal direction of the said tape and coated in a polymer compound. The width of the tape is adjusted to suit the angle at which the turns are wound, to make the turns contiguous.

When the said tube is flattened, because the turns are perfectly contiguous, the complex strip obtained consists of two layers of continuous reinforcing elements passing from one layer to the other, the said reinforcing elements being parallel in one layer and crossed from one layer to the other at angles with respect to the circumferential direction that are identical in terms of absolute value. Producing a tube with contiguous turns makes it possible to obtain linear reinforcing elements in each of the layers, with the exception of the axial ends of each of the layers, where the reinforcing elements form loops to ensure the continuity between one layer and the next.

This linearity of the reinforcing elements in each of the layers allows constant longitudinal rigidity and constant shear rigidity to be conferred upon the entire width of the said layers that form the complex strip.

The flattening of the said tube also makes it possible to obtain coupling between the layers so that the radial distance between the respective reinforcing elements of each of the layers is substantially equivalent to the sum of the thickness of polymer compound in the liner radially on the outside of the reinforcing elements of the radially inner layer and of the thickness of polymer compound in the liner radially on the inside of the reinforcing elements of the radially outer layer, the said liners coming into contact with one another.

Such coupling between the two crown layers encourages high longitudinal rigidity and high shear rigidity. An indirect consequence of this is that the tire becomes lighter as it would require several layers of complex strip if the layers of which these strips were formed were not sufficiently coupled so that the desired longitudinal and shear rigidities could be obtained.

According to one particularly advantageous embodiment, the reinforcing elements of the said complex strip make an angle of between 10 and 45° with the circumferential direction.

As explained previously, the angle formed by the reinforcing elements with the circumferential direction corresponds to the angle that the turns of the tube make with the longitudinal direction of the tube before this tube is flattened. Small angles may make the complex strip easier to produce using the method as described hereinabove.

According to a first alternative form of embodiment, the complex strip is wound circumferentially with an axial overlap, preferably equal to at least half the width of the said complex strip. Axial overlap makes it possible to avoid the creation of regions in which the presence of reinforcing elements is not as great. Having an axial overlap of at least half the width of the complex strip makes it possible to produce simultaneously four working layers the reinforcing elements of which are crossed from one layer to the next, the angles of the reinforcing elements being identical in terms of absolute value in each of the layers.

An axial overlap at least equal to two-thirds of the width of the complex strip may allow at least six working layers to be produced simultaneously.

According to another alternative form of embodiment of the invention, the complex strip is wound circumferentially to form juxtaposed turns. Such an alternative form of embodiment allows two working layers to be created without creating any excess thickness.

According to a first embodiment of the invention, the reinforcing elements of the complex strip are made of metal.

Advantageously, according to this first embodiment of the invention, the reinforcing elements of the complex strip are metal reinforcing elements having a secant modulus at 0.7% elongation of between 10 and 120 GPa and a maximum tangent modulus of less than 150 GPa.

According to a preferred embodiment, the secant modulus of the reinforcing elements at 0.7% elongation is less than 100 GPa and greater than 20 GPa, preferably is comprised between 30 and 90 GPa and more preferably still is less than 80 GPa.

For preference also, the maximum tangent modulus of the reinforcing elements is less than 130 GPa and more preferably still, less than 120 GPa.

The modulus values expressed hereinabove are measured on a curve of tensile stress as a function of elongation determined with a preload of 20 MPa divided by the cross section of metal in the reinforcing element, the tensile stress corresponding to a measured tension divided by the cross section of metal in the reinforcing element.

The modulus values for the same reinforcing elements can be measured on a curve of tensile stress as a function of elongation determined with a preload of 10 MPa divided by the overall cross section of the reinforcing element, the tensile stress corresponding to a measured tension divided by the overall cross section of the reinforcing element. The overall cross section of the reinforcing element is the cross section of a composite reinforcing element made of metal and rubber, the latter having notably penetrated the reinforcing element during the tire curing phase.

According to this formulation relating to the overall cross section of the reinforcing element, the reinforcing elements of the complex strip are metal reinforcing elements having a secant modulus of between 5 and 60 GPa at 0.7% elongation and a maximum tangent modulus of less than 75 GPa.

According to a preferred embodiment, the secant modulus of the reinforcing elements at 0.7% elongation is less than 50 GPa and greater than 10 GPa, preferably is comprised between 15 and 45 GPa and more preferably still is less than 40 GPa.

For preference also, the maximum tangent modulus of the reinforcing elements is less than 65 GPa and more preferably still, less than 60 GPa.

According to a preferred embodiment, the reinforcing elements of the complex strip are metal reinforcing elements having a curve of tensile stress as a function of relative elongation that exhibits shallow gradients for small elongations and a substantially constant and steep gradient for higher elongations. Such reinforcing elements in the additional ply are generally known as “bi-modulus” elements.

According to a preferred embodiment of the invention, the substantially constant and steep gradient appears starting from a relative elongation of between 0.1% and 0.5%.

The various characteristics of the reinforcing elements as mentioned hereinabove are measured on reinforcing elements taken from tires.

Reinforcing elements more particularly suited to producing the complex strip according to the invention are, for example, assemblies of formula 21.23, the construction of which is 3×(0.26+6×0.23) 4.4/6.6 SS; this stranded cord consists of 21 elementary threads of formula 3×(1+6), with 3 strands twisted together, each consisting of 7 threads, one thread forming a central core with a diameter equal to 26/100 mm and 6 wound threads with a diameter equal to 23/100 mm. Such a cord has a secant modulus equal to 45 GPa at 0.7% and a maximum tangent modulus equal to 98 GPa, measured on a curve of tensile stress as a function of elongation determined with a preload of 20 MPa divided by the cross section of metal in the reinforcing element, the tensile stress corresponding to a measured tension divided by the cross section of metal in the reinforcing element. On a curve of tensile stress as a function of elongation determined with a preload of 10 MPa divided by the overall cross section of the reinforcing element, the tensile stress corresponding to a measured tension divided by the overall cross section of the reinforcing element, this cord of formula 21.23 has a secant modulus equal to 23 GPa at 0.7% and a maximum tangent modulus equal to 49 GPa.

Likewise, another example of reinforcing elements is an assembly of formula 21.28, the construction of which is 3×(0.32+6×0.28) 6.2/9.3 SS. This cord has a secant modulus equal to 56 GPa at 0.7% and a maximum tangent modulus equal to 102 GPa, measured on a curve of tensile stress as a function of elongation determined with a preload of 20 MPa divided by the cross section of metal in the reinforcing element, the tensile stress corresponding to a measured tension divided by the cross section of metal in the reinforcing element. On a curve of tensile stress as a function of elongation determined with a preload of 10 MPa divided by the overall cross section of the reinforcing element, the tensile stress corresponding to a measured tension divided by the overall cross section of the reinforcing element, this cord of formula 21.28 has a secant modulus equal to 27 GPa at 0.7% and a maximum tangent modulus equal to 49 GPa.

The use of such reinforcing elements in the complex strip notably makes it possible to produce the tube and to flatten the said tube simply using the method described hereinabove, at the same time limiting the risks of the reinforcing elements breaking and improving the ability of the complex strip to remain flat after it has been produced, notably when the angle formed between the circumferential direction and the reinforcing elements of the two working crown layers is greater than 40°.

The metal elements are preferably steel cords.

According to a second embodiment of the invention, the reinforcing elements of the complex strip are made of a textile material such as materials of nylon, aramid, PET, rayon, polyketone type.

According to a third embodiment of the invention, the reinforcing elements of the complex strip are made of a hybrid material. These may be textile hybrid materials such as reinforcing elements consisting of aramid and of nylon like those described in document WO 02/085646 or alternatively may be hybrid materials combining textile materials and metallic materials.

Producing the complex strip using textile or hybrid reinforcing elements notably makes it possible to afford advantages particularly in terms of endurance without too greatly penalizing the mass of the tire, even when compared to a single additional layer of metal reinforcing elements for example oriented circumferentially.

According to a preferred alternative form of embodiment of the invention, the said additional complex strip is radially adjacent to the edge of the radially outer working crown layer.

According to other alternative forms of embodiment, the additional complex strip may be radially adjacent to one and/or other of the working layers; it may even, according to some alternative forms of the invention, have an axially outer end, axially on the outside of the end of one or more working layers; alternatively still, it may be at least 1.5 mm distant from the end of at least one working layer.

According to one preferred embodiment of the invention, the axially widest working crown layer is radially on the inside of the other working crown layers.

For preference also, the difference between the axial width of the axially widest working crown layer and the axial width of the axially least wide working crown layer is between 5 and 30 mm.

According to an advantageous alternative form of embodiment of the invention, the angle formed with the circumferential direction by the reinforcing elements of the working crown layers is less than 30° and preferably less than 25°.

According to an alternative form of embodiment of the invention, the working crown layers comprise reinforcing elements, which are crossed from one ply to the other, and make with the circumferential direction angles that vary in the axial direction, the said angles between greater on the axially outer edges of the layers of reinforcing elements by comparison with the angles of the said elements measured at the circumferential mid-plane. Such an embodiment of the invention makes it possible to increase the circumferential rigidity in certain regions but decrease it in others, notably in order to reduce the compression loadings on the carcass reinforcement.

One preferred embodiment of the invention is also for the crown reinforcement to be supplemented radially on the outside by at least one supplementary layer, known as a protective layer, of reinforcing elements know as elastic elements, oriented with respect to the circumferential direction at an angle of between 10° and 45° and in the same direction as the angle formed by the inextensible elements of the working layer radially adjacent to it.

The protective layer may have an axial width smaller than the axial width of the least wide working layer. The said protective layer may also have an axial width greater than the axial width of the least wide working layer, such that it overlaps the edges of the least wide working layer. The protective layer formed of elastic reinforcing elements may, in the latter of the abovementioned instances, have an axial width that is less than or greater than the axial width of the widest crown layer.

When the protective layer is axially narrower than the axially least wide working crown layer, and the said working crown layer is radially speaking the outermost working layer, the invention advantageously makes provision for the edge of the protective layer to be radially adjacent to and preferably radially on the outside of at least the axially inner edge of the additional complex strip.

By comparison with the foregoing alternative forms of the invention, in order to obtain such an embodiment of the invention, whereby the edge of the protective layer is radially adjacent to and on the outside of the additional complex strip, either the end of the protective layer is axially further towards the outside, or the axially inner end of the additional layer is axially further towards the inside. In other words, either the protective layer is axially wider or the additional complex strip is axially wider while at the same time being axially elongated towards the inside.

According to either one of the embodiments of the invention mentioned hereinabove, the crown reinforcement may be further supplemented, for example radially between the carcass reinforcement and the radially innermost working layer, by a triangulation layer consisting of inextensible reinforcing elements which make an angle greater than 40° with the circumferential direction, and preferably an angle in the same direction as the angle formed by the reinforcing elements of the radially closest layer of the carcass reinforcement.

One advantageous embodiment of the invention is for the crown reinforcement of the tire further to comprise at least one continuous layer of circumferential reinforcing elements the axial width of which is preferably less than the axial width of the axially widest working crown layer.

The presence, in the tire according to the invention, of at least one continuous layer of reinforcing elements, may contribute to obtaining near-infinite axial radii of curvature of the various reinforcing layers in a region centred on the circumferential mid-plane, and this contributes towards the endurance performance of the tire.

According to an advantageous embodiment of the invention, the reinforcing elements of at least one continuous layer of circumferential reinforcing elements are metal reinforcing elements that have a secant modulus of between 10 and 120 GPa at 0.7% elongation and a maximum tangent modulus of less than 150 GPa.

According to a preferred embodiment, the secant modulus of the reinforcing elements at 0.7% elongation is less than 100 GPa and greater than 20 GPa, preferably is comprised between 30 and 90 GPa and more preferably still is less than 80 GPa.

For preference also, the maximum tangent modulus of the reinforcing elements is less than 130 GPa and more preferably still, less than 120 GPa.

The modulus values expressed hereinabove are measured on a curve of tensile stress as a function of elongation determined with a preload of 20 MPa divided by the cross section of metal in the reinforcing element, the tensile stress corresponding to a measured tension divided by the cross section of metal in the reinforcing element.

The modulus values for the same reinforcing elements can be measured on a curve of tensile stress as a function of elongation determined with a preload of 10 MPa divided by the overall cross section of the reinforcing element, the tensile stress corresponding to a measured tension divided by the overall cross section of the reinforcing element. The overall cross section of the reinforcing element is the cross section of a composite element made of metal and rubber, the latter having notably penetrated the reinforcing element during the tire curing phase.

According to this formulation relating to the overall cross section of the reinforcing element, the reinforcing elements of at least one layer of circumferential reinforcing elements are metal reinforcing elements having a secant modulus of between 5 and 60 GPa at 0.7% elongation and a maximum tangent modulus of less than 75 GPa.

According to a preferred embodiment, the secant modulus of the reinforcing elements at 0.7% elongation is less than 50 GPa and greater than 10 GPa, preferably is comprised between 15 and 45 GPa and more preferably still is less than 40 GPa.

For preference also, the maximum tangent modulus of the reinforcing elements is less than 65 GPa and more preferably still, less than 60 GPa.

According to a preferred embodiment, the reinforcing elements of at least one continuous layer of circumferential reinforcing elements are metal reinforcing elements having a curve of tensile stress as a function of relative elongation that exhibits shallow gradients for small elongations and a substantially constant and steep gradient for higher elongations. Such reinforcing elements in the continuous layer of circumferential reinforcing elements are generally known as “bi-modulus” elements.

According to a preferred embodiment of the invention, the substantially constant and steep gradient appears starting from a relative elongation of between 0.1% and 0.5%.

The various characteristics of the reinforcing elements as mentioned hereinabove are measured on reinforcing elements taken from tires.

Reinforcing elements more particularly suited to producing at least one continuous layer of circumferential reinforcing elements according to the invention are, for example, assemblies of formula 21.23, the construction of which is 3×(0.26+6×0.23) 4.4/6.6 SS; this stranded cord consists of 21 elementary threads of formula 3×(1+6), with 3 strands twisted together, each consisting of 7 threads, one thread forming a central core with a diameter equal to 26/100 mm and 6 wound threads with a diameter equal to 23/100 mm. Such a cord has a secant modulus equal to 45 GPa at 0.7% and a maximum tangent modulus equal to 98 GPa, measured on a curve of tensile stress as a function of elongation determined with a preload of 20 MPa divided by the cross section of metal in the reinforcing element, the tensile stress corresponding to a measured tension divided by the cross section of metal in the reinforcing element. On a curve of tensile stress as a function of elongation determined with a preload of 10 MPa divided by the overall cross section of the reinforcing element, the tensile stress corresponding to a measured tension divided by the overall cross section of the reinforcing element, this cord of formula 21.23 has a secant modulus equal to 23 GPa at 0.7% and a maximum tangent modulus equal to 49 GPa.

Likewise, another example of reinforcing elements is an assembly of formula 21.28, the construction of which is 3×(0.32+6×0.28) 6.2/9.3 SS. This cord has a secant modulus equal to 56 GPa at 0.7% and a maximum tangent modulus equal to 102 GPa, measured on a curve of tensile stress as a function of elongation determined with a preload of 20 MPa divided by the cross section of metal in the reinforcing element, the tensile stress corresponding to a measured tension divided by the cross section of metal in the reinforcing element. On a curve of tensile stress as a function of elongation determined with a preload of 10 MPa divided by the overall cross section of the reinforcing element, the tensile stress corresponding to a measured tension divided by the overall cross section of the reinforcing element, this cord of formula 21.28 has a secant modulus equal to 27 GPa at 0.7% and a maximum tangent modulus equal to 49 GPa.

The use of such reinforcing elements in at least one continuous layer of circumferential reinforcing elements notably makes it possible to maintain satisfactory rigidities in the layer even after the shaping and curing steps in conventional manufacturing processes.

According to a second embodiment of the invention, the circumferential reinforcing elements of a continuous layer may be formed of inextensible metal elements cut to form lengths very much shorter than the length of the circumference of the least longest layer, but preferably greater than 0.1 times the said circumference, the cuts between links being axially staggered with respect to one another. For preference also, the tension elastic modulus per unit width of the continuous layer of circumferential reinforcing elements is less than the tension elastic modulus, measured under the same conditions, of the most extensible working crown layer. Such an embodiment makes it possible, in a simple way, to give the continuous layer of circumferential reinforcing elements a modulus that can easily be adjusted (through the choice of the gaps between the lengths in one and the same row) but in all instances lower than the modulus of the layer consisting of the same metal elements, but continuous ones, the modulus of the continuous layer of circumferential reinforcing elements being measured on a vulcanized layer of cut elements, taken from the tire.

According to a third embodiment of the invention, the circumferential reinforcing elements of a continuous layer are corrugated metal elements, the ratio a/λ of the amplitude of the corrugation wave to the wavelength being at most equal to 0.09. For preference, the tension elastic modulus per unit width of the continuous layer of circumferential reinforcing elements is less than the tension elastic modulus, measured under the same conditions, of the most extensible working crown layer.

The metal elements of these various embodiments are preferably steel cords.

According to one alternative form of the invention, at least one continuous layer of circumferential reinforcing elements is arranged radially between two working crown layers.

According to this last alternative form of embodiment, the continuous layer of circumferential reinforcing elements makes it possible more significantly to limit the compression loadings of the reinforcing elements of the carcass reinforcement than a similar layer fitted radially on the outside of the other working crown layers. It is preferably separated radially from the carcass reinforcement by at least one working layer so as to limit the stress loadings of the said reinforcing elements and not subject them to excessive fatigue.

Advantageously also, in the case of a continuous layer of circumferential reinforcing elements positioned radially between two working crown layers, the axial widths of the working crown layers radially adjacent to the layer of circumferential reinforcing elements are greater than the axial width of the said layer of circumferential reinforcing elements.

Further details and advantageous features of the invention will become apparent hereinafter from the description of some exemplary embodiments of the invention with reference to FIGS. 1 to 4 which depict:

FIG. 1: a perspective view, with cutaway, of a complex strip according to the invention;

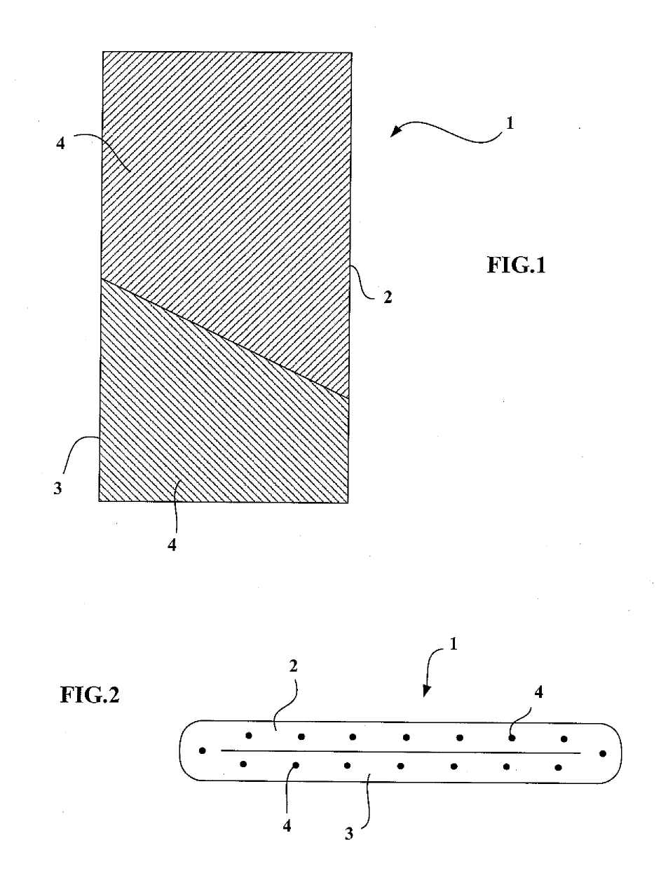

FIG. 2: a meridian view of the complex strip of FIG. 1;

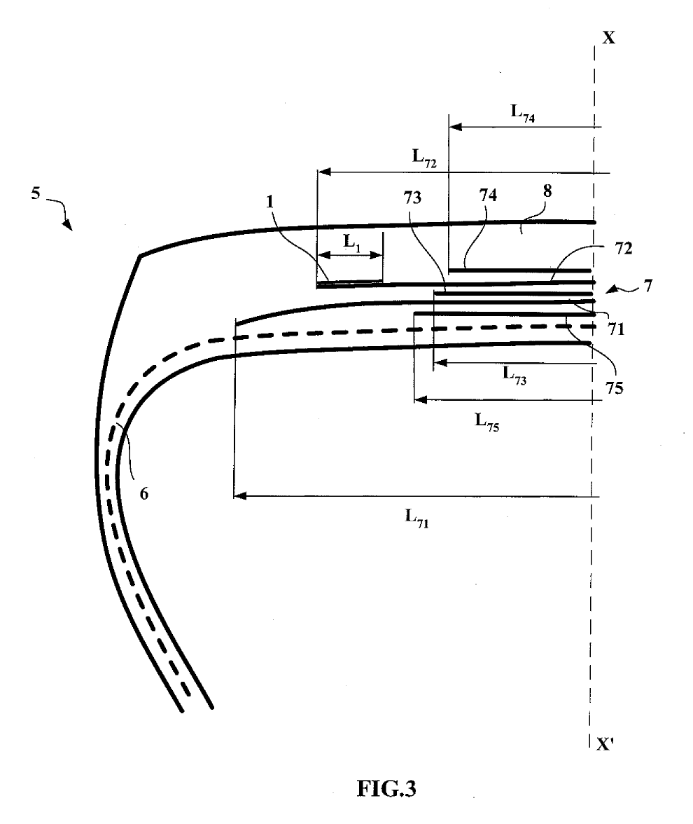

FIG. 3: a meridian view of a tire comprising the complex strip of FIG. 1, according to a first embodiment of the invention; and

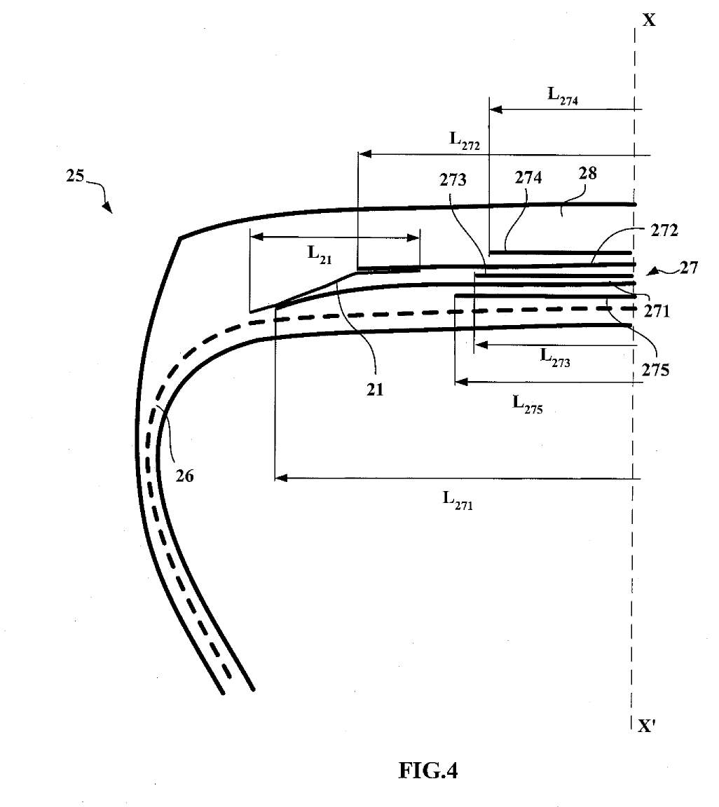

FIG. 4: a meridian view of a tire comprising the complex strip of FIG. 1, according to a second embodiment of the invention.

To make them easier to understand, the figures are not drawn to scale. FIGS. 3 and 4 depict only a half-view of a tire which extends symmetrically with respect to the axis XX′ which represents the circumferential mid-plane, or equatorial plane, of a tire.

FIG. 1 depicts a diagram, with cutaway, of a complex strip 1 consisting of two layers 2, 3 of reinforcing elements 4 making an angle with the circumferential direction, parallel within one layer and crossed from one layer to the other with angles with respect to the circumferential direction that are identical in terms of absolute value.

The complex strip 1 is obtained according to a method which involves flattening a tube fowled by winding in contiguous turns at a given angle with respect to the longitudinal direction of the tube, a tape in which reinforcing elements are parallel to one another and to the longitudinal direction of the said tape and coated in a polymer compound. When the tube is flattened, because the turns are perfectly contiguous, the complex strip obtained consists of two layers of continuous reinforcing elements passing from one layer to the other.

Producing a tube with contiguous turns makes it possible to obtain linear reinforcing elements 4 in each of the layers, with the exception of the axial ends of each of the layers where the reinforcing elements form loops to provide continuity from one layer to the next.

FIG. 2 corresponds to a meridian view of a schematic depiction of such a complex strip 1. This figure shows that the complex strip 1 consists of the two layers 2, 3 of reinforcing elements 4 in which the said reinforcing elements are continuous from one layer to the other.

The complex strip 1 thus depicted in the figures has the advantage of constituting a system of two layers of reinforcing elements that are parallel to one another and crossed from one layer to the next, the said layers not having any free ends of reinforcing elements.

The complex strip 1 is produced from a tape consisting of reinforcing elements having a diameter equal to 1.14 mm embedded in two liners 0.11 mm thick. Each of the layers thus has a thickness of 1.36 mm and the complex strip has a thickness of 2.72 mm, the radial distance between the respective reinforcing elements of each of the crown layers being equal to 0.22 mm. The radial distance between the respective reinforcing elements of each of the crown layers is equal to the sum of the thicknesses of the liner radially on the outside of the reinforcing elements of the radially inner layer and of the liner radially on the inside of the reinforcing elements of the radially outer layer.

FIG. 3 illustrates a tire 5 of dimension 295/60 R 22.5 X. The said tire 5 comprises a radial carcass reinforcement 6 anchored in two beads, not depicted in the figure. The carcass reinforcement is formed as a single layer of metal cords. This carcass reinforcement 6 is hooped by a crown reinforcement 7, formed radially from the inside towards the outside:
of a first working layer 71 formed of non-hooped inextensible metal cords 11.35, which are continuous over the entire width of the ply, oriented at an angle equal to 18°,
of a continuous layer 73 of circumferential reinforcing elements interposed between the working layers 71 and 72,
of a second working layer 72 formed of unhooped inextensible metal cords 11.35 which are continuous over the entire width of the ply, oriented at an angle equal to 18° and crossed with the metal cords of the layer 71; the layer 72 is axially smaller than the layer 71,
of a complex strip 1 laid by circumferential winding. Winding in this example is performed in such a way as to obtain contiguous turns. The winding of the complex strip 1 thus forms two radially superposed layers of reinforcing elements that are parallel to one another within one and the same layer and crossed from one layer to the next with no free ends. According to other alternative forms of embodiment of the invention, the turns formed when winding the complex strip may overlap axially, to form a greater number of radially superposed layers; they are, for example, axially overlapped by ⅔ of the width of the complex strip, during the winding, to form six radially superposed layers. The reinforcing elements in the additional complex strip are of the PET 144×2 type.

The axial width L₇₁ of the first working layer 71 is equal to 234 mm.

The axial width L₇₂ of the second working layer 72 is equal to 216 mm.

The axial width L₇₃ of the continuous layer 73 is equal to 196 mm, and therefore smaller than the widths of the working layers 71 and 72.

The additional complex strip 1 has a width equal to 18 mm. It is radially adjacent to and on the outside of the radially outermost working layer 72 and extends axially as far as the end of the said working layer 72.

The crown reinforcement is itself capped by a tread strip 8.

The tire 5 also comprises a protective layer 74 formed of elastic metal cords 18×23 the axial width of which is equal to 160 mm, and a supplementary layer of reinforcing elements 75, know as the triangulation layer, of a width substantially equal to 200 mm and formed of inextensible metal cords 9×28. The reinforcing elements in this layer 75 form an angle of about 60° with the circumferential direction and are oriented in the same direction as the reinforcing elements in the working layer 71. This layer 75 is notably able to contribute towards reacting the transverse compression loadings to which all the reinforcing elements in the crown region of the tire are subjected.

FIG. 4 illustrates another embodiment of a tire 51 according to the invention which, by comparison with the embodiment of FIG. 3, has an additional complex strip 21 inserted between the two working layers 71, 72. The layer 21 is actually radially adjacent to and on the inside of the layer 72.

Furthermore, the tire 25 further differs from the one depicted in FIG. 1 in that the additional complex strip 21 extends beyond the axially outer end of the layer 272 and comes into contact with the layer 271 to extend axially beyond the end of the working layer 271.

The additional complex strip 21 has a width L₂ equal to 42 mm; it has a region of axial overlap with the layer 72 equal to 18 mm and a region of overlap with the layer 71 equal to 3 mm.

The invention must not be interpreted as being restricted to the alternative forms of embodiment described. Other alternative forms of embodiment of the invention, which have not been depicted in the figures, relate for example to the case of an additional complex strip which extends axially beyond the axially outer end of the radially outer working layer and which remains a distance greater than 1.5 mm away from the end of the radially inner working layer. In such an alternative form of embodiment, the axially outer layer of the additional complex strip may lie axially between the ends of the two working layers or may alternatively be situated beyond the end of the axially widest working layer.

Alternative forms of embodiment of the invention may also, for example, have the additional complex strip situated radially adjacent to the radially inner working layer so that it is on the outside or on the inside of the said working layer. According to other embodiments in accordance with the invention, the additional complex strip may only be in contact with the radially outer working crown layer or alternatively may only be in contact with the radially inner working crown layer either being radially adjacent to and on the outside of one of these working layers or being radially adjacent to and on the inside thereof.

Tests have been run with the tire produced according to the invention as depicted in FIG. 3 and compared against a reference tire that was identical, but produced with a conventional configuration, that is to say without the additional complex strip.

The tests were run using reinforcing elements in the additional complex strip that were made of textile of the PET 144×2 type.

The first endurance tests were run by fitting identical vehicles with each of the tires and making each of the vehicles run a course in a straight line, the tires being subjected to loading in excess of the nominal loading in order to accelerate this type of test.

The reference vehicle with the conventional tires was associated with a loading per tire of 3600 kg at the start of the run, progressing up to a loading of 4350 kg at the end of the run.

The vehicle with the tires according to the invention was associated with a loading per tire of 3800 kg at the start of the run, progressing up to a loading of 4800 kg at the end of the run.

The tests were stopped when the tire became damaged and/or no longer worked in the normal way.

The tests thus run demonstrated that the vehicle fitted with tires according to the invention covered a distance equivalent to the distance covered by the reference vehicles. It is therefore apparent that the tires according to the invention perform better than the reference tires because they were subjected to higher loading stresses.

Other endurance tests were run on a test machine by alternating sequences of cornering to the left, cornering to the right and then driving in a straight line under loading conditions varying from 60 to 200% of the nominal load and with thrusts varying from 0 to 0.35 times the applied load. The speeds were between 30 and 70 km/h. The tests were stopped when the tire became damaged and/or no longer operated normally.

The results obtained showed gains in distances covered by the tires according to the invention that were in excess of 54% higher than the distances covered by the reference tires.

1. A tire with a radial carcass reinforcement comprising a crown reinforcement formed of at least two working crown layers of inextensible reinforcing elements, crossed from one ply to the other making angles of between 10° and 45° with the circumferential direction, and itself radially capped by a tread strip, said tread strip being connected to two beads via two sidewalls, and, in each shoulder, at least two layers being formed by a circumferential winding of a complex strip formed of two layers including continuous reinforcing elements passing from one layer to the other, said reinforcing elements being parallel within a layer and crossed from one layer to the other at angles with respect to the circumferential direction that are identical in terms of absolute value, wherein said additional complex strip is radially adjacent to the edge of a working crown layer, and wherein the axially outer end of said additional complex strip is situated a distance from the equatorial plane of the tire that is at least equal to the distance separating from said plane that end of the working layer to which it is adjacent.

2. The tire according to claim 1, wherein the radial distance between the respective reinforcing elements of each of the crown layers forming a complex strip is less than the thickness of a crown layer and preferably less than half the thickness of a crown layer.

3. The tire according to claim 1, wherein the reinforcing elements of said complex strip make an angle of between 10 and 45° with the circumferential direction.

4. The tire according to claim 1, wherein the complex strip is wound circumferentially with an axial overlap.

5. The tire according to claim 1, wherein the complex strip is wound circumferentially to form juxtaposed turns.

6. The tire according to claim 1, wherein the reinforcing elements of the complex strip are made of metal.

7. The tire according to claim 6, wherein the reinforcing elements of the complex strip are metal reinforcing elements having a secant modulus at 0.7% elongation of between 10 and 120 GPa and a maximum tangent modulus of less than 150 GPa.

8. The tire according to claim 1, wherein the reinforcing elements of the complex strip are made of a textile material.

9. The tire according to claim 1, wherein the reinforcing elements of the complex strip are made of a hybrid material.

10. The tire according to claim 1, wherein said additional complex strip is radially adjacent to the edge of the radially outer working crown layer.

11. The tire according to claim 10, wherein said additional complex strip is radially on the outside of the edge of the radially outer working crown layer.

12. The tire according to claim 1, wherein the axially widest working crown layer is radially on the inside of the other working crown layers.

13. The tire according to claim 1, wherein the crown reinforcement is supplemented radially on the outside by at least one supplementary ply, known as a protective ply, of reinforcing elements know as elastic elements, oriented with respect to the circumferential direction at an angle of between 10° and 45° and in the same direction as the angle formed by the inextensible elements of the working ply radially adjacent to it.

14. The tire according to claim 1, wherein the crown reinforcement comprises a triangulation layer formed of metal reinforcing elements that make angles in excess of 40° with the circumferential direction.

15. The tire according to claim 1, wherein the crown reinforcement comprises at least one continuous layer of circumferential reinforcing elements.

16. The tire according to claim 15, wherein the axial width of at least one continuous layer of circumferential reinforcing elements is less than the axial width of the axially widest working crown layer.

17. The tire according to claim 15, wherein at least one continuous layer of circumferential reinforcing elements is arranged radially between two working crown layers.

18. The tire according to claim 17, wherein the axial widths of the working crown layers radially adjacent to the continuous layer of circumferential reinforcing elements are greater than the axial width of said continuous layer of circumferential reinforcing elements.

19. The tire according to claim 1, wherein the complex strip is wound circumferentially with an axial overlap equal to at least half the width of said complex strip.
